(19) United States
(12) Patent Application Publication
(10) Pub. No.: US 2007/0251833 A1
(43) Pub. Date: Nov. 1, 2007

(54) Electrochemical Reduction of Metal Oxides

(76) Inventors: Ivan Ratchev, New South Wales (AU); Rene Ignacio Olivares, New South Wales (AU); Gregory David Rigby, New South Wales (AU); Sergey Alexander Bliznyukov, New South Wales (AU)

Correspondence Address: BRINKS HOFER GILSON & LIONE, P.O. BOX 10395, CHICAGO, IL, 60610, US

(21) Appl. No.: 11/668,507

(22) Filed: Jan. 30, 2007

Related U.S. Application Data
(63) Continuation-in-part of application No. PCT/AU05/01134, filed on Aug. 1, 2005.

(30) Foreign Application Priority Data
Jul. 30, 2004 (AU) 2004904310

(51) Int. Cl. C02F 1/461

(52) U.S. Cl. 205/687

(57) ABSTRACT

A process for minimising reoxidation of reduced material is disclosed. The process applies to reduced material that has been formed by a process of electrochemically reducing a metal oxide feed material, such as titania, in a solid state in an electrolytic cell containing a molten electrolyte. The process for minimising reoxidation includes applying an electrical potential to reduced material at least while the reduced material remains immersed in the molten electrolyte.

This application is a continuation-in-part of and claims priority to PCT application PCT/AU2005/001134 filed on Aug. 1, 2005 published in English on Feb. 2, 2006 as WO 2006/010228 and to Australian application no. 2004904310 filed Jul. 30, 2004, the entire contents of each are incorporated herein by reference.

### FIELD OF THE INVENTION

The present invention relates to electrochemical reduction of metal oxides.

### BACKGROUND OF THE INVENTION

The present invention relates particularly, although by no means exclusively, to electrochemical reduction of metal oxide feed material in the form of powders and/or pellets in an electrolytic cell to produce reduced material, namely metal having a low oxygen concentration, typically no more than 0.2% by weight.

The present invention is concerned with minimising reoxidation of reduced material that has been produced by electrochemical reduction of metal oxide feed material in an electrolytic cell.

### SUMMARY OF THE INVENTION

The present invention provides a process for minimising reoxidation of reduced material after reduced material has been formed by a process of electrochemically reducing a metal oxide feed material in a solid state in an electrolytic cell containing a molten electrolyte which includes applying an electrical potential to reduced material at least while the reduced material remains immersed in the molten electrolyte.

### DETAILED DESCRIPTION OF THE EMBODIMENTS

The present invention was made during the course of an on-going research project on electrochemical reduction of metal oxide feed material being carried out by the applicant. The research project has focussed on the reduction of titania (TiO₂).

During the course of the research project the applicant has carried out a series of experiments, initially on a laboratory scale and more recently on a pilot plant scale, investigating the reduction of metal oxide feed material in the form of titania in electrolytic cells comprising a pool of molten CaCl₂-based electrolyte, an anode formed from graphite, and a range of cathodes.

The CaCl₂-based electrolyte used in the experiments was a commercially available source of CaCl₂, which decomposed on heating and produced a very small amount of CaO.

The applicant has operated the laboratory and pilot plant electrolytic cells at a potential above the decomposition potential of CaO and below the decomposition potential of CaCl₂. The applicant found that the cells electrochemically reduced titania to titanium with low concentrations of oxygen, ie concentrations less than 0.2 wt. %, at these potentials.

The applicant has operated the laboratory and pilot plant cells under a wide range of different operating parameters and conditions. The applicant has operated the laboratory electrolytic cells on a batch basis with titania in the form of pellets and larger solid blocks in the early part of the laboratory work and titania powder in the later part of the work. The applicant has also operated the laboratory electrolytic cells on a batch basis with other metal oxides.

Recent pilot plant work carried out by the applicant has been on a pilot plant cell that was set up to operate initially on a continuous basis and subsequently on a batch basis. The pilot plant work has enabled the applicant to gain an appreciation of the issues involved in operating the electrochemical reduction process on an industrial, as opposed to a laboratory, scale.

One issue that has been addressed by the applicant in the research project is the issue of reoxidation of reduced material that has been produced in electrolytic cells by electrochemical reduction of metal oxide feed material in a solid state. Inevitably, these cells will operate at high temperatures. For example, in the case of electrochemical reduction of titania in molten CaCl₂, the molten electrolyte will be at a temperature of the order of 900-1200° C. Irrespective of whether the cells are operated on a batch or a semi-continuous or a continuous basis, at the end of processing metal oxide feed material to a required degree of reduction in the cells it is necessary to remove reduced material from the cells and to cool the reduced material to a lower temperature, for example ambient temperature, prior to further processing the reduced material.

Inevitably, in the case of reduced material such as titanium metal there is a significant driving force for undesirable reoxidation while the reduced material cools from 900-1200° C. to a lower temperature.

The applicant has found somewhat surprisingly that the significant driving force for undesirable reoxidation applies, not only when reduced material is removed from molten electrolyte in an electrolytic cell and is exposed directly to air, but also while the reduced material is immersed in the electrolyte. Whilst the amount of reoxidation that occurs in the electrolyte may be small, in the context of an objective of the applicant of obtaining high purity reduced material with ppm concentrations of oxygen, the extent of reoxidation can have a significant impact on the final product quality.

The applicant has found that one effective option for minimising reoxidation of reduced material that has been formed by a process of electrochemically reducing metal oxide feed material in a solid state in an electrolytic cell is to apply an electrical potential to reduced material at least while the reduced material remains immersed in the electrolyte.

More particularly, the applicant has found from experimental work that there are lower levels of reoxidation in situations where reduced material in contact with a molten electrolyte is under an applied potential compared to situations where reduced material in contact with the same molten electrolyte is not under an applied potential.

According to the present invention there is provided a process for minimising reoxidation of reduced material after reduced material has been formed by a process of electrochemically reducing a metal oxide feed material in a solid state in an electrolytic cell containing a molten electrolyte which includes applying an electrical potential to reduced material at least while the reduced material remains immersed in the molten electrolyte.

The process may include applying the electrical potential to reduced material at least while the reduced material remains immersed in the electrolyte in the electrolytic cell and maintaining the temperature of the electrolyte at or close to a cell operating temperature for reducing metal oxide feed material during this period.

In the situation described in the preceding paragraph, preferably the process includes removing the reduced material from the electrolytic cell and cooling the reduced material to a lower temperature required for subsequent handling or processing the reduced material.

Preferably, the lower temperature is a solidification temperature for the electrolyte that is retained on the reduced material when it is removed from the molten electrolyte so that the retained electrolyte freezes on the reduced material. Preferably, the process includes cooling the reduced material to the lower temperature quickly so as to minimise reoxidation of the reduced material as it cools to the lower temperature. Preferably, the process includes quenching the reduced material to the lower temperature. Preferably, the process includes removing the reduced material from the electrolytic cell and cooling the reduced material so that molten electrolyte freezes on the surface of the reduced material and at least partially encapsulates the material and thereby lowers the reoxidation rate. Preferably, the process includes cooling the reduced material in a non-oxidising atmosphere. In the above-described situation, typically the process includes interrupting the applied potential to the reduced material as a consequence of removing the reduced material from the electrolyte in the electrolytic cell.

Alternatively to the above, the process may include applying the electrical potential to reduced material while reduced material cools in contact with molten electrolyte from a cell operating temperature for reducing metal oxide feed material to a lower temperature.

Specifically, the process described in the preceding paragraph may include:
(a) applying the electrical potential to reduced material and molten electrolyte that is in contact with the reduced material while the reduced material and molten electrolyte cool from the cell operating temperature to a lower temperature at which the electrolyte is still molten; (b) removing or separating the reduced material from the molten electrolyte; and (c) cooling the reduced material to a further lower temperature required for subsequent handling or processing the reduced material.

Step (a) may include applying the electrical potential to reduced material and molten electrolyte while the reduced material is in the cell. Step (a) may alternatively include applying the electrical potential to reduced material and molten electrolyte after the reduced material and at least part of the molten electrolyte have been transferred from the cell into a separate treatment vessel.

Preferably, the further lower temperature is a solidification temperature for the electrolyte that is retained on the reduced material when it is removed from the molten electrolyte so that the retained electrolyte freezes on the reduced material.

Preferably, step (c) includes cooling the reduced material to the further lower temperature quickly so as to minimise reoxidation of the reduced material as it cools to the further lower temperature. Preferably, step (c) includes quenching the reduced material. Preferably, step (c) includes cooling the reduced material to the further lower temperature in a non-oxidising atmosphere.

The subsequent handling or processing the reduced material described above may include by way of example washing the reduced material to remove retained electrolyte on the reduced material.

Preferably the metal oxide feed material is in a powder and/or a pellet form. Preferably the metal oxide feed material is a titanium oxide. More preferably, the titanium oxide is titania.

Preferably, the electrolyte is a CaCl₂-based electrolyte containing CaO.

The applied potential may be any suitable potential. Typically, the applied potential is the cell operating potential.

The process may be carried out on a batch basis, a semi-continuous basis, and a continuous basis.

According to the present invention there is provided a process for electrochemically reducing metal oxide feed material in a solid state in an electrolytic cell that includes an anode, a cathode, a molten electrolyte, and metal oxide feed material in contact with the molten electrolyte, which electrochemical process includes the steps of: (a) applying an electrical potential across the anode and the cathode and electrochemically reducing metal oxide feed material in contact with the molten electrolyte and producing reduced material; and (b) minimising reoxidation of reduced material after reduced material has been formed in accordance with the above-described process for minimising reoxidation of reduced material.

Preferably the metal oxide feed material is a titanium oxide. More preferably, the titanium oxide is titania.

Preferably, the electrolyte is a CaCl₂-based electrolyte containing CaO. In the case of a CaCl₂-based electrolyte containing CaO preferably the electrochemical reduction process includes applying a potential across the anode and the cathode that is above the decomposition potential of CaO and below the decomposition of CaCl₂.

The electrochemical reduction process may be carried out on a batch basis, a semi-continuous basis, and a continuous basis. The electrochemical reduction process may be carried out in a cell that contains a bath of molten electrolyte and metal oxide feed material in the form of powders and/or pellets, an anode, and a cathode. The electrochemical reduction process may be carried out as a single stage or a multi-stage process.

The experimental work carried out by the applicant included an experiment carried out with 2 pellets of titania in a laboratory-scale electrolytic cell with a molten bath of commercially available CaCl₂, a carbon anode extending into the bath, and the pellets forming parts of separate cathodes extending into the bath.

The experiment was carried out under the following conditions.
Mass of CaCl₂=681.0 g
Mass of TiO₂: Pellet1=1.0167 and Pellet 2=1.0139 g.
Temperature=1100° C.
Cell voltage—3.0 V.
Duration at 1100° C.=4 h 5 min power off to the furnace.
Duration under potential—Pellet 1=4 h 44 min. Pellet 2=4 hr 5 min.
Temperature of withdrawal of both pellets from the molten bath=815° C.
CaO content of the bath before the run=0.065%.
CaO content of the bath after the run=0.071%.

During the experiment, both pellets were initially reduced under the above conditions for a period of 4 hours and 5 minutes. At the end of this period, the furnace heating the cell was turned off and pellet 2 was disconnected from the power source. The pellets remained in the cell and cooled as the cell cooled for a further 39 minutes. During the cooling period, pellet 1 remained connected to the power source and pellet 2 was disconnected from the power source. At the end of the period of 39 minutes the electrolyte had cooled to 815° C. Both pellets were then removed from the cell and were allowed to cool to ambient temperature and were washed and the oxygen content of the pellets was analysed.

It was found that pellet 1, ie the pellet that was cooled under potential, had an oxygen content of 0.1159 wt % and that pellet 2, ie the pellet that was cooled without potential, had a significantly higher oxygen content of 0.3971 wt. %

The above experiment demonstrated the effectiveness in cooling reduced material under potential.

The experimental work carried out by the applicant included experiments in a pilot plant cell which is an extension of the above-described laboratory-scale electrolytic cell. The pilot plant cell contained a molten bath of commercially available CaCl₂, a carbon anode, and a cathode, and a plurality of the above-described pellets forming a part of the cathode.

The pilot plant was operated at an electrolyte temperature of 900° C. and a cell voltage of 3.0 V for a period of time sufficient to electrochemically reduce titania in the pellets to titanium having a low oxygen concentration. After the titania had been reduced for the required time, the pellets were maintained under the applied potential until the time the pellets were withdrawn from the cell and the electrical circuit was interrupted as a consequence of removing the pellets from the electrolyte.

The pellets were removed into a non-oxidising atmosphere, specifically an argon purged atmosphere. The removed pellets were quenched to freeze molten electrolyte retained on the pellets so as to at least partially encapsulate the pellets with the electrolyte material. The applicant found that the pellets, as processed as described above, did not reoxidise significantly.

Many modifications may be made to the present invention described above without departing from the spirit and scope of the invention.

1. A process for minimising reoxidation of reduced material after reduced material has been formed by a process of electrochemically reducing a metal oxide feed material in a solid state in an electrolytic cell containing a molten electrolyte which includes applying an electrical potential to reduced material at least while the reduced material remains immersed in the molten electrolyte.

2. The process defined in claim 1 includes applying the electrical potential to reduced material at least while the reduced material remains immersed in the electrolyte in the electrolytic cell and maintaining the temperature of the electrolyte at or close to a cell operating temperature for reducing metal oxide feed material during this period.

3. The process defined in claim 1 includes removing the reduced material from the electrolytic cell and cooling the reduced material to a lower temperature required for subsequent handling or processing the reduced material.

4. The process defined in claim 3 includes cooling the reduced material to the lower temperature quickly so as to minimise reoxidation of the reduced material as it cools to the lower temperature.

5. The process defined in claim 4 includes quenching the reduced material to the lower temperature.

6. The process defined in claim 1 includes removing the reduced material from the electrolytic cell and cooling the reduced material so that molten electrolyte freezes on the surface of the reduced material and at least partially encapsulates the material and thereby lowers the reoxidation rate.

7. The process defined in claim 6 includes quenching the reduced material.

8. The process defined in claim 3 includes interrupting the applied potential to the reduced material as a consequence of removing the reduced material from the electrolyte in the electrolytic cell.

9. The process defined in claim 1 includes applying the electrical potential to reduced material while reduced material cools in contact with molten electrolyte from a cell operating temperature for reducing metal oxide feed material to a lower temperature.

10. The process defined in claim 9 includes the steps of:
(a) applying the electrical potential to reduced material and molten electrolyte that is in contact with the reduced material while the reduced material and molten electrolyte cool from the operating temperature of the cell to a lower temperature at which the electrolyte is still molten;
(b) removing or separating the reduced material from the molten electrolyte; and
(c) cooling the reduced material to a further lower temperature required for subsequent handling or processing the reduced material.

11. The process defined in claim 10 wherein step (a) includes applying the electrical potential to reduced material and molten electrolyte while the reduced material is in the cell.

12. The process defined in claim 10 wherein step (a) includes applying the electrical potential to reduced material and molten electrolyte after the reduced material and at least part of the molten electrolyte have been transferred from the cell into a separate treatment vessel.

13. The process defined in claim 10 wherein step (c) includes cooling the reduced material to the further lower temperature quickly so as to minimise reoxidation of the reduced material as it cools to the further lower temperature.

14. The process defined in claim 10 wherein step (c) includes quenching the reduced material.

15. The process defined in claim 1 wherein the metal oxide feed material is in a powder and/or a pellet form.

16. The process defined in claim 1 wherein the metal oxide feed material is a titanium oxide.

17. The process defined in claim 1 wherein the electrolyte is a CaCl₂-based electrolyte containing CaO.

18. A process for electrochemically reducing metal oxide feed material in a solid state in an electrolytic cell that includes an anode, a cathode, a molten electrolyte, and metal oxide feed material in contact with the molten electrolyte, which electrochemical process includes the steps of:
(a) applying an electrical potential across the anode and the cathode and electrochemically reducing metal oxide feed material in contact with the molten electrolyte and producing reduced material; and
(b) minimising reoxidation of reduced material after reduced material has been formed in accordance with the process for minimising reoxidation of reduced material defined in any one of the preceding claims.

19. The process defined in claim 18 wherein, in the case of a CaCl₂-based electrolyte containing CaO, the electrochemical reduction process (a) includes applying a potential across the anode and the cathode that is above the decomposition potential of CaO and below the decomposition of CaCl₂.
